(19) United States
(12) Patent Application Publication
(10) Pub. No.: US 2026/0341963 A1
(43) Pub. Date: Oct. 29, 2026

(54) MAGNETO-ELECTRIC ANTENNA WITH PASSIVE ANTENNA

(71) Applicant: Elta Systems Ltd., Ashdod (IL)

(72) Inventors: Michael ELMAN, Kiryat Malachi (IL); Reuven BAUER, Rehovot (IL)

(21) Appl. No.: 19/646,768

(22) Filed: Apr. 14, 2026

(30) Foreign Application Priority Data
Apr. 24, 2025 (IL) 320487

(51) Int. Cl. H01Q 7/00; H01Q 1/38

(52) U.S. Cl. CPC H01Q 7/00; H01Q 1/38

(57) ABSTRACT

Embodiments disclosed herein present a technical solution to s technical problem of insufficient bandwidth of a magnetoelectric (ME) antenna for certain system implementations. One or more passive radiator layers are stacked above a primary antenna that has magnetic and electric radiators that generate orthogonal magnetic and electric fields. Each passive radiator layer(s) includes at least one passive radiator, which is capacitively coupled to the primary antenna. The passive radiator layer(s) may increase the bandwidth of the primary antenna, as demonstrated in the simulation results below.

This application claims priority from Israeli Patent Application No. 320487 filed on the 24April 2025, which is incorporated herein by reference in its entirety.

### TECHNICAL FIELD

The present disclosure, in some embodiments, thereof, relates to a magneto electric (ME) antenna and, more particularly, but not exclusively, to an ME antenna utilized as a radiating element for a phased array antenna.

### BACKGROUND

Conventional antennas rely primarily on electric dipole radiation, which often results in size constraints, inefficiencies, and limited bandwidth. In many modern applications, such as wireless communication, satellite systems, and IoT devices, there is a growing demand for compact, high-efficiency antennas with improved radiation characteristics.

The magnetoelectric (ME) dipole antenna is a type of complementary antenna which performs as a combination of an electric dipole and a magnetic dipole. Typically, the antenna geometry includes a planar electric dipole and a vertical patch antenna. In some cases a proximity coupled feed is utilized to excite the antenna. While magneto-electric antennas offer many benefits, including improved polarization diversity and compactness, their complexity, potential size constraints, and challenges with impedance matching and noise sensitivity are some of the notable disadvantages. Additionally, some magneto-electric antenna configurations suffer from narrower bandwidth compared to other wideband antennas like log-periodic or spiral antennas.

### SUMMARY

ME antennas integrate both electric and magnetic radiators within a single structure. By utilizing orthogonally oriented electric and magnetic fields, these antennas may achieve superior radiation characteristics relative to conventional dipole antennas.

In some cases it is desired to use ME antennas as radiating elements of a phased array antenna. However, when the grid of the phased array is increased in the direction of the antenna's polarization it is almost impossible to match the antenna over wide scan angles. The reason for this is weak electromagnetic coupling as a result of the wider spacing.

Embodiments of the disclosure present a technical solution to the technical problem of insufficient bandwidth of an ME antenna for certain system implementations. The technical solution is to stack one or more passive radiator layers above a primary antenna that has magnetic and electric radiators which generate orthogonal magnetic and electric fields. Each passive radiator layer(s) include at least one passive radiator, which is capacitively coupled to the primary antenna. The passive radiator layer(s) may increase the bandwidth of the primary antenna, as demonstrated in the simulation results below.

As used herein, according to some embodiments of the disclosure the term passive radiator layer(s) includes both a single passive radiator layer or multiple passive radiator layers.

Embodiments of the disclosure also present a technical solution to the technical problem of weak electromagnetic coupling between ME antenna elements in a phased array antenna. The passive radiator(s) may be positioned on the respective passive radiator layer so as to increase the coupling between the antenna elements when they are used in a phased array antenna. Thus, the antenna may be matched over wider scan angles that would not be achievable by the primary antenna alone without the passive radiator layer.

Technical effects of some embodiments of the invention include one or more of:
1) Widens the scan angle of phased array antennas.
2) Significant improvement in the active impedance matching of the phased array antenna over wide scan angles, which as a result significantly improves the antenna efficiency.
3) Different configurations of passive layers may be used with the same primary antenna design, in order to tailor antenna performance to a particular implementation without redesign of the primary antenna.
4) Inexpensive and easy to manufacture. The addition of the passive layer(s) has minimal effect on the manufacturing process, as it only requires stacking separate layer(s) on top of the primary antenna.
5) Compactness - the addition of the passive layer(s) has minimal effect on the form factor of the primary antenna, as the primary antenna dimensions are increased only by the size of the passive layer(s).
6) Improved bandwidth relative to the same primary antenna without passive radiator layer(s).

According to a first aspect of some embodiments of the present invention there is provided a magneto-electric antenna comprising:
a primary antenna comprising:
at least one magnetic radiator, configured to generate a magnetic field;
at least one electric radiator, configured to generate an electric field oriented orthogonally to the magnetic field; and
at least one antenna feed, configured to couple at least one feed line to the at least one magnetic radiator and to the at least one electric radiator; and
at least one passive radiator layer stacked above the primary antenna, each of the at least one passive radiator layers respectively comprising at least one passive radiator capacitively coupled to the primary antenna.

According to some embodiments of the invention, the at least one passive radiator layers are physically separated from the primary antenna by a dielectric substance.

According to some embodiments of the invention, the at least one passive radiator layers are conductively disconnected from the primary antenna.

According to some embodiments of the invention, at least one of the passive radiator layers includes a respective dielectric substrate having an upper surface and a lower surface, the at least one passive radiator being disposed on the top surface and the primary antenna being located below the bottom surface.

According to some embodiments of the invention, at least one of the passive radiator layers includes a respective dielectric substrate having an upper surface and a lower surface, the at least one passive radiator being disposed on the bottom surface and the primary antenna being located below the bottom surface, wherein the at least one passive radiator is conductively disconnected from the primary antenna.

According to some embodiments of the invention, the at least one passive radiator layers comprise a patterned conductive material disposed on a surface of a respective dielectric substrate, the patterned conductive material forming a resonator.

According to some embodiments of the invention, each of the at least one passive radiator layers includes an array of passive radiators.

According to some embodiments of the invention, the electric radiator includes at least one dipole antenna.

According to some embodiments of the invention, the magneto-electric antenna further includes a radome.

According to some embodiments of the invention, at least one of the passive radiator layers is incorporated into the radome.

According to some embodiments of the invention, the radome is positioned above the passive radiator layer.

According to some embodiments of the invention, the magneto-electric antenna is a printed-circuit antenna.

According to some embodiments of the invention, the magneto-electric antenna is a machined metal antenna.

According to some embodiments of the invention, the magneto-electric antenna is a three-dimensional (3D) printed antenna.

According to some embodiments of the invention, the primary antenna is dual-polarized.

According to a second aspect of some embodiments of the present invention there is provided an array antenna, comprising an array of magneto-electric antennas, each of the magneto-electric antennas respectively comprising:
a primary antenna comprising: at least one magnetic radiator, configured to generate a magnetic field;
at least one electric radiator, configured to generate an electric field oriented orthogonally to the magnetic field; and
at least one antenna feed, configured to couple at least one feed line to the at least one magnetic radiator and to the at least one electric radiator; and
at least one passive radiator layer stacked above the primary antenna, each of the at least one passive radiator layers respectively comprising at least one passive radiator capacitively coupled to the primary antenna.

According to some embodiments of the invention, the primary antennas are dual-polarized.

According to some embodiments of the invention, the array antenna further includes transmit/receive (T/R) modules associated with respective magneto-electric antennas, configured to adjust at least one of a respective phase and a respective amplitude of signals applied to the magneto-electric antennas such that the array antenna is operable as a phased array antenna.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or and computer program products according to embodiments of the present disclosure.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the invention, unless otherwise indicated. In the drawings like reference numerals are used to indicate corresponding parts.

In block diagrams and flowcharts, optional elements/components and optional stages may be included within dashed boxes.

In the figures:

FIG. 1A is a simplified exploded view of an ME antenna with a single passive radiator layer, according to some embodiments of the disclosure;

FIG. 1B is a simplified isometric view of an ME antenna with a single passive radiator layer, according to some embodiments of the disclosure;

FIG. 1C is a simplified exploded view of an ME antenna with multiple passive radiator layers, according to some embodiments of the disclosure;

FIGS. 2A-2B are simplified cutaway side views of an ME antenna, according to respective exemplary embodiments of the disclosure;

FIGS. 3A-3B are simplified illustrations of exemplary ME dipole antennas which may serve as the primary antenna, according to respective exemplary embodiments of the disclosure;

FIG. 3C is a simplified illustration of an ME antenna with a single passive radiator layer, according to exemplary embodiments of the disclosure;

FIG. 4 is a simplified block diagram of an antenna array, according to some embodiments of the invention;

FIG. 5 illustrates the basic structure of a simulated phased array grid of antenna elements, according to some embodiments of the disclosure;

FIG. 6 shows simulation results of the return loss of a phased array antenna with and without a passive radiator layer when scanning out to 60 degrees;

FIG. 7 shows simulation results of the return loss of a phased array antenna with and without a passive radiator layer when scanning out to 50 degrees; and

FIG. 8 shows simulation results of the return loss of a single ME antenna with and without a passive radiator layer.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

The present disclosure, in some embodiments, thereof, relates to a magneto electric (ME) antenna and, more particularly, but not exclusively, to an ME antenna utilized as a radiating element for a phased array antenna.

### I. Magneto-electric Antenna with one or more Passive Layers

According to some embodiments of the disclosure, the magneto-electric antenna includes a primary antenna and at least one passive radiator layer stacked above it. The primary antenna includes at least one magnetic radiator configured to generate a magnetic field and at least one electric radiator configured to generate an electric field orthogonally oriented to the magnetic field. At least one antenna feed couples one or more feed lines to both the magnetic radiator(s) and the electric radiator(s). Each passive radiator layer includes at least one passive radiator capacitively coupled to the primary antenna.

As used herein, according to some embodiments of the invention, the term “antenna” means a device that converts electric current into electromagnetic waves and/or vice versa. The specific antenna architecture is based its application, for example the receive and/or transmit wavelengths, transmission power, etc.

As used herein, according to some embodiments of the invention, the term “radiator” means a component of the antenna that emits and absorbs electric and/or magnetic waves.

As used herein, according to some embodiments of the disclosure, the terms “above” and “stacked above” refer to the relative locations of the primary antenna and the passive radiator layer. They do not imply any physical orientation of the ME antenna.

According to some embodiments of the disclosure, the passive radiators are conductively disconnected from the primary antenna. The passive radiators are electromagnetically coupled by the primary antenna and are not conductively connected to the antenna feed.

According to some embodiments of the disclosure, the passive radiator layers are physically separated from the primary antenna by a dielectric substance, for example by an air gap.

According to some embodiments, the passive radiator layers are physically separated from each other by a dielectric substance, for example by an air gap.

Examples of materials that may be used as dielectric substrates include but are not limited to: polytetrafluoroethylene (PTFE), epoxy glass, ceramics, foam, polystyrene, Poly(methyl methacrylate) (PMMA), fused quartz, alumina, and silicon.

According to some embodiments of the disclosure, the ME antenna includes a radome above the passive radiator layer(s). The radome may provide mechanical protection and environmental shielding.

In one example, at least one passive radiator layer is incorporated into the radome. In an alternate example, the radome is positioned over the passive radiator layer(s).

According to some embodiments of the disclosure, the ME antenna includes a cavity which encases the primary antenna and the passive radiator layer.

The principles, uses and implementations of the teachings herein may be better understood with reference to the accompanying description and figures. Upon perusal of the description and figures present herein, one skilled in the art will be able to implement the teachings herein without undue effort or experimentation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

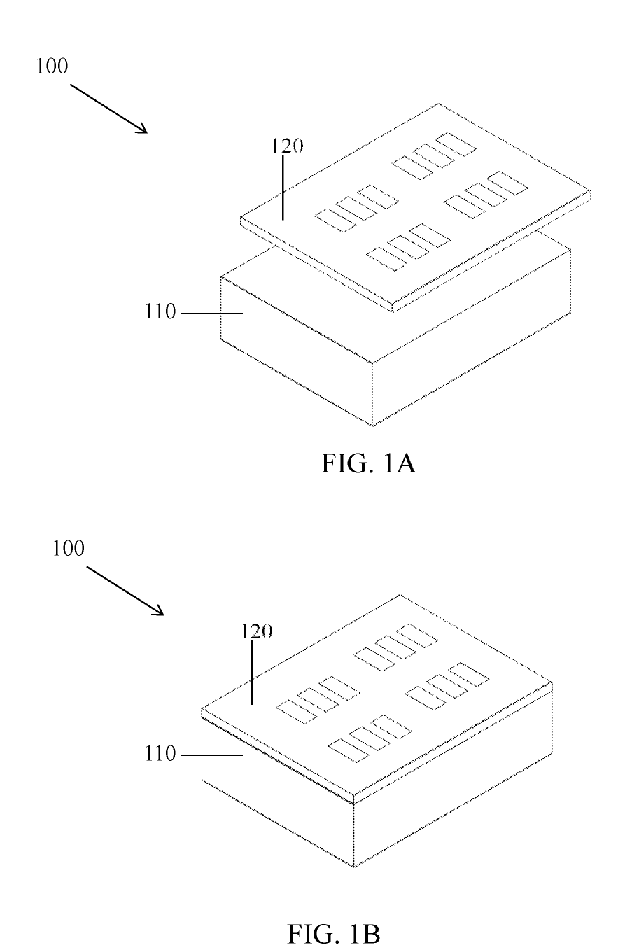

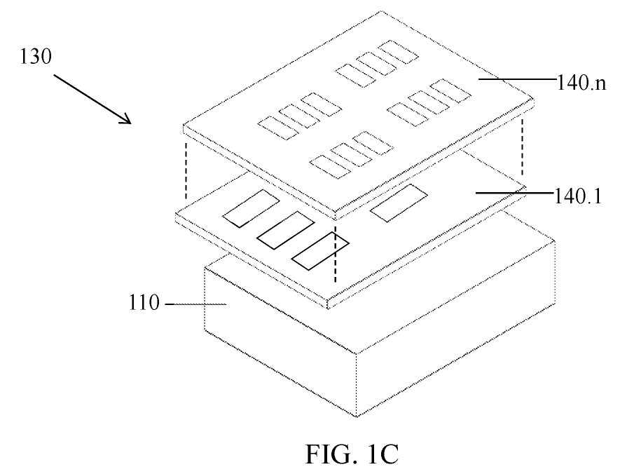

Reference is now made to FIGS. 1A-1B, which are simplified views of an ME antenna according to some embodiments of the disclosure. FIG. 1A is an exploded view, which shows primary antenna 110 and passive radiator layer 120 as separate elements. Passive radiator layer 120 is not conductively coupled to the feed line. FIG. 1B shows passive radiator layer 120 stacked directly above primary antenna 110. However, although they are primary antenna 110 and passive radiator layer 120 are physically connected, the passive radiators of primary radiator layer 120 are not conductively connected to the electric radiator(s), magnetic radiator(s) or antenna feed(s) of primary antenna 110.

Reference is now made to FIG. 1A-1B, which are simplified views of an ME antenna according to some embodiments of the disclosure. FIG. 1C is an exploded view, which shows primary antenna 110 and multiple passive radiator layers 140.1-140.n. Passive radiator layers 140.1-140.n are not conductively coupled to the feed line.

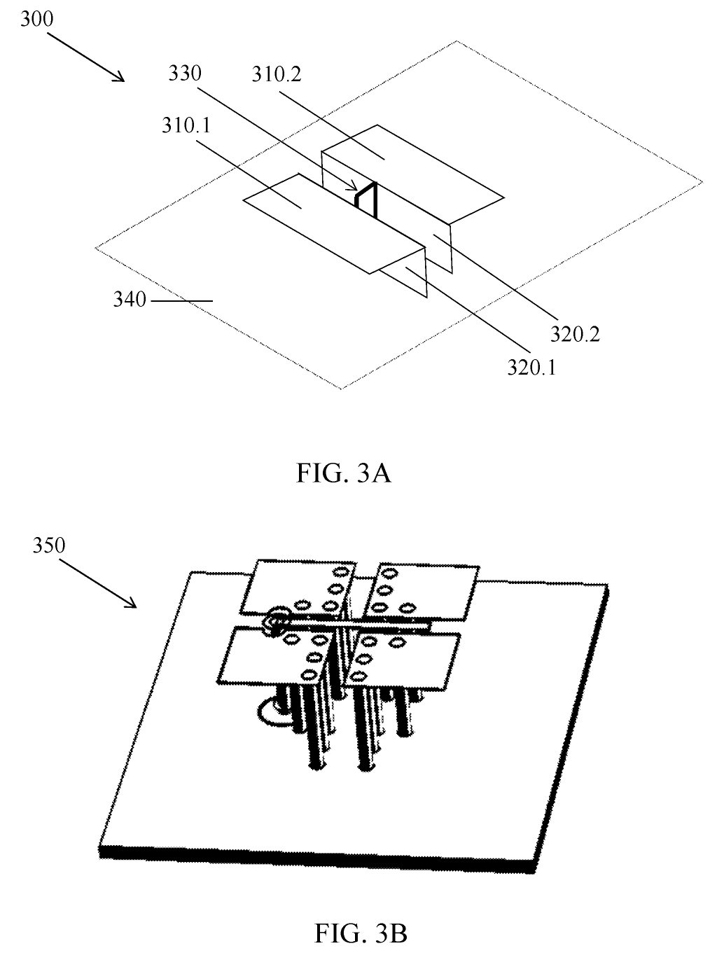

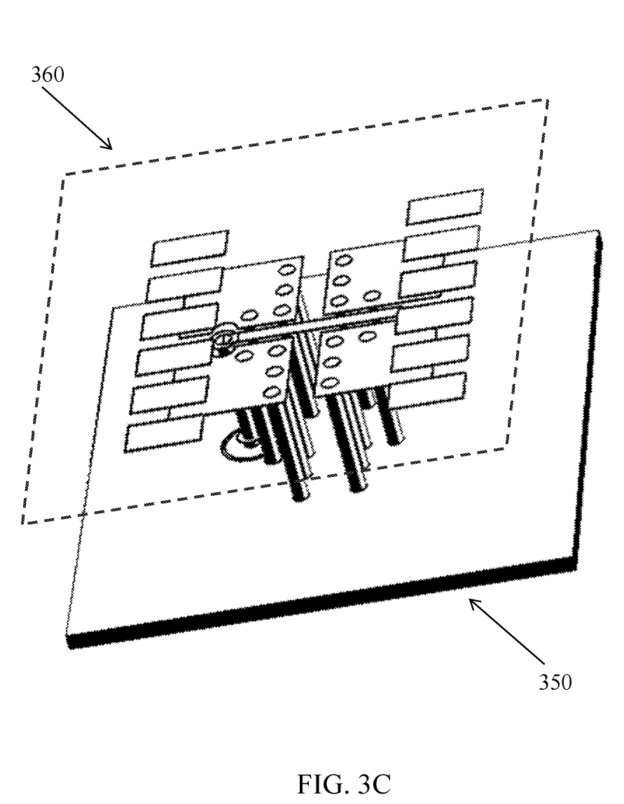

For clarity, FIGS. 1A-1C show primary antenna 110 as a single block. In practice, primary antenna 110 includes sub-components, including but not limited to the magnetic radiator(s), electric radiator(s) and feed line(s). Simplified examples of primary EM antennas are illustrated in FIGS. 3A-3B.

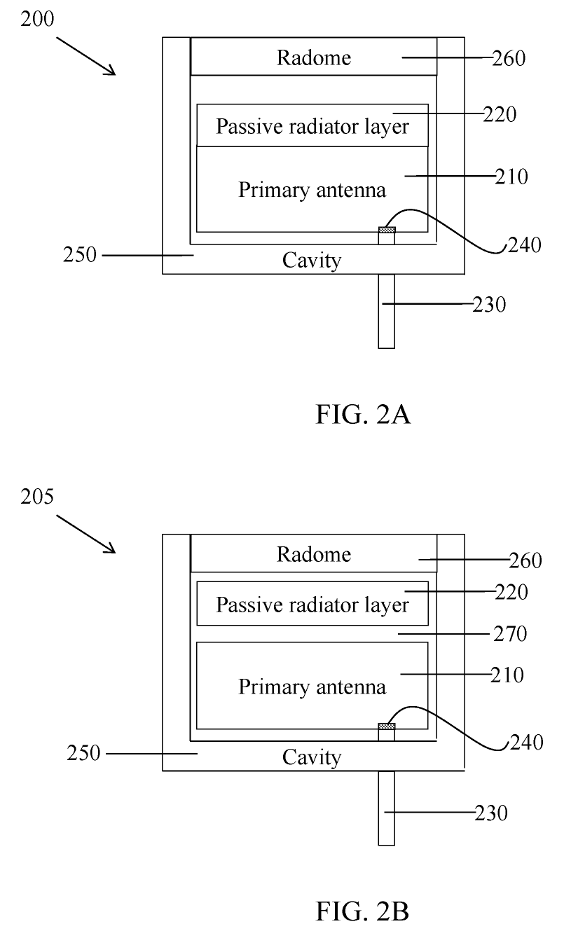

Reference is now made to FIGS. 2A-2B, which are simplified cutaway side views of an ME antenna, according to respective exemplary embodiments of the disclosure. For clarity, FIGS. 2A-2B illustrate an ME antenna with a single passive radiator layer. Other embodiments according to the disclosure may include two or more passive radiator layers stacked above each other.

Passive radiator layer 220 is stacked above primary antenna 210. Feed line 230 is coupled to primary antenna 210 by antenna feed 240. Passive radiator layer 220 and primary antenna 210 are encased in cavity 250. Radome 260 is above passive radiator layer 220. In FIG. 2A, passive radiator layer 220 and primary antenna 210 of ME antenna 200 are physically adjacent. In FIG. 2B, passive radiator layer 220 and primary antenna 210 of ME antenna 205 are physically separated by dielectric substance 270.

ME antenna 200 of FIG. 2A has the advantage in that radome 260 may be placed on the antenna after the antenna is completely designed. Since the radome is placed at a distance from the antenna, the effect on the antenna electrical performance is fairly minor. In addition, the type of radome may be changed or modified depending on the environment in which the antenna is placed in.

ME antenna 205 of FIG. 2B has the advantage of being much cheaper and much easier to manufacture since the radome is an integral part of the antenna structure. In this configuration, the radome takes up very little volume.

Embodiments of the ME antenna of the disclosure may be manufactured using any manufacturing technology suitable for the given antenna.

In one example, the magneto-electric antenna is a printed-circuit antenna.

In a second example, the magneto-electric antenna is a machined metal antenna.

In a third example, the magneto-electric antenna is a three-dimensional (3D) printed antenna.

### I.a. Primary antenna

The primary antenna includes at least one magnetic radiator configured to generate a magnetic field, at least one electric radiator configured to generate an electric field orthogonally oriented to the magnetic field and at least one antenna feed to couple one or more feed lines to both the magnetic radiator(s) and the electric radiator(s).

According to some embodiments of the disclosure, primary antenna 110 further includes a ground plane.

According to some embodiments of the disclosure, primary antenna 110 is dual-polarized and has two antenna feeds. The magneto-electric antenna according to some embodiments of the disclosure is an excellent candidate for a dual-polarized antenna, in particular, as an antenna element within a phased array. This is because, the isolation between the polarizations is quite high even when scanning to far-out scan angles. This is not the case for other types of dual-polarized phased array elements.

The primary antenna may be of any suitable type, structure, design, materials and so forth that results in the generation of orthogonal magnetic and electrical fields when the primary antenna is excited by a signal from one or more feed lines, according to the design requirements.

According to some embodiments of the disclosure, the electric radiator(s) include at least one dipole antenna.

There are many ME antenna configurations that may be suitable as a primary antenna, including but not limited to:
a. ME dipole antenna;
b. Folded ME dipole antenna;
c. ME dipole with dielectric loading;
d. Triangular loop ME antenna; e. Rectangular loop ME antenna; f. Dual-polarized ME antenna; g. Circularly-polarized ME antenna; and h. ME antennas with single or multiple probes.

FIG. 3A is an isometric illustration of a simplified structure of a first non-limiting exemplary ME dipole antenna which may serve as the primary antenna. Antenna 300 includes two electric dipoles (310.1 and 310.2) and two magnetic dipoles (320.1 and 320.2). Probe 330 couples a feed line to electric dipoles 310.1 and 310.2 and to magnetic dipoles 320.1 and 320.2. Ground plane 340 acts as a reflector.

FIG. 3B is an isometric illustration of a simplified structure of a second non-limiting exemplary ME dipole antenna which may serve as the primary antenna. Antenna 350 has four electric dipoles and four magnetic dipoles which are oriented perpendicularly to respective electric dipoles.

FIG. 3C is a simplified isometric illustration an exemplary ME dipole antenna, with primary antenna 350 and a single passive radiator layer 360 (dielectric substrate not shown for clarity).

### I.b. Passive radiator layer

The passive radiator layer(s) are stacked above the primary antenna. Each passive radiator layer includes at least one passive radiator capacitively coupled to the primary antenna.

Various parameters may be used to improve or optimize the passive radiators. These parameters include but are not limited to:
1) The height of passive radiators above the primary antenna
2) The shape of the passive radiators
3) The number of passive radiators on top of each element
4) Their position on the element.

Every array will have its own optimization values, depending on factors such as the size of the array, the frequency of operation, the scan volume of the antenna and the polarization of the antenna.

When ME antennas according to the disclosure serve as elements in a phased array antenna as described in more detail below, the passive antenna layer(s) may enhance the performance of the phased array antenna by increasing the mutual coupling between antenna elements. This enables the enables the antenna to scan to far out scan angles by providing a better impedance match at these angles. The effect is especially pronounced in large phased array antennas (e.g. 256 elements or more).

According to some embodiments of the invention, the passive radiator layer includes one or more passive radiators on the surface of a dielectric substrate. According to some embodiments of the disclosure, the passive radiator layer includes an array of passive radiators (for example as shown in FIGS. 1A-1B).

The size of the passive radiators, shape of the passive radiators and arrangement of the passive radiators on the layer may be any suitable size, shape and arrangement for the particular implementation. The size, shapes and arrangements shown in and described with regard to the figures are not limiting.

According to some further embodiments of the invention, the passive radiator layer is a dielectric substrate with a patterned conductive material on its surface, such that the patterned conductive material forms one or more resonators.

In a first example, the passive radiator(s) are disposed on the top surface of the dielectric substrate and the primary antenna is located below the bottom surface of the dielectric substrate. In a second example, the passive radiator(s) are disposed on the bottom surface of the dielectric substrate and the primary antenna is located below the bottom surface of the dielectric substrate, with the passive radiator(s) conductively disconnected from the primary antenna (for example by a non-conductive spacer).

According to some embodiments of the disclosure, the passive radiator layer is manufactured by etching a pattern on a dielectric substrate coated with a conductive material (for example gold, copper or tin).

### II. Antenna array

According to some embodiments of the disclosure, magneto-electric antenna with passive radiator layer(s) as described herein serve as antenna elements (denoted herein ME antenna elements) of an array antenna.

Each of the ME antenna elements in the array respectively includes a primary antenna and passive radiator layer(s) above the primary antenna. Each primary antenna includes at least one magnetic radiator configured to generate a magnetic field, at least one electric radiator configured to generate an electric field oriented orthogonally to the magnetic field, and at least one antenna feed configured to couple at least one feed line to the magnetic radiator(s) and to the electric radiator(s). Each of the at least one passive radiator layer respectively includes at least one passive radiator capacitively coupled to the primary antenna.

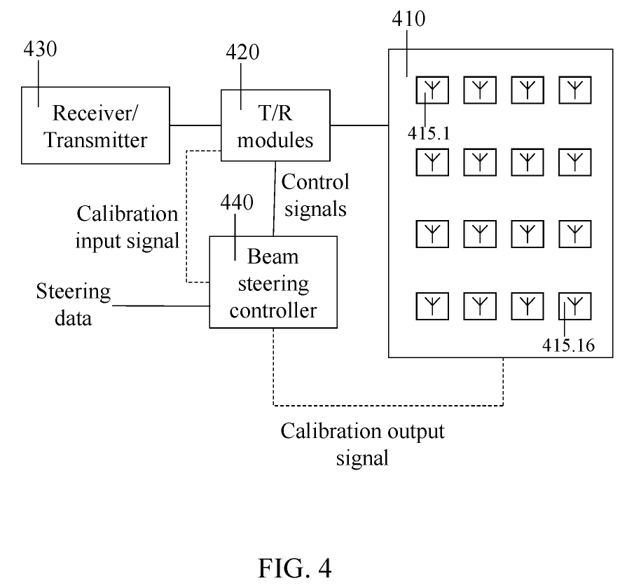

An example of an antenna array comprising ME antenna elements is described below in reference to FIG. 4 (antenna array 410).

The ME antenna elements may be configured according to any embodiment of the disclosure. Optionally, the ME antenna elements include any technically feasible combination of one or more of the following features:
i) The passive radiator layer(s) are physically separated from the primary antenna by a dielectric substance;
ii) The passive radiator layer(s) are conductively disconnected from the primary antenna.
iii) The passive radiator layer(s) include a dielectric substrate. In one example, in the passive radiator layer directly above the primary antenna the passive radiator(s) are on the upper surface of the dielectric substrate and the primary antenna is located below the bottom surface. In a second example, the passive radiator layer directly above the primary antenna the passive radiator(s) are on the bottom surface of the dielectric substrate, the primary antenna is located below the bottom surface and is conductively disconnected from the passive radiator(s).
iv) The passive radiator layer(s) include a dielectric substrate with a patterned conductive material disposed on its surface. The patterned conductive material forms a passive resonator.
v) The passive radiator layer(s) include respective arrays of passive radiators. vi) The electric radiator includes at least one dipole antenna.
vi) The ME antenna includes a radome. In a first example, the passive radiator layer is incorporated into the radome. In a second example, the radome is positioned above the passive radiator layer.
vii) The ME antenna is one of: a printed-circuit antenna, a machined metal antenna and a 3D printed antenna.
viii) The primary antenna is dual-polarized.

### II.a. Phased array antenna

According to some embodiments of the disclosure, the array of ME antenna elements is configured to function as a phased array antenna.

As used herein, according to some embodiments of the invention, the term “phased array antenna” means an array of antenna elements that are controlled to produce a desired radiation pattern.

According to some embodiments of the disclosure, the array antenna includes transmit/receive (T/R) modules associated with respective ME antenna elements. The T/R modules adjust a respective phase and/or respective amplitude of signals applied to the ME antenna elements, in order to produce the desired radiation pattern.

Reference is now made to FIG. 4, which is a simplified block diagram of an antenna array, according to some embodiments of the invention.

Antenna array 410 includes an array of ME antenna elements. For clarity, antenna array 410 is illustrated in a non-limiting manner as a four by four array of ME antenna elements 415.1-415.16. As will be appreciated by the skilled person, other configurations of antenna elements may be used. For example, the antenna arrays may consist of different numbers of antenna elements, different arrangements of the antenna elements to form an array, different spacings between antenna elements, and so forth.

Optionally, antenna array 410 is part of a phased array antenna that includes T/R modules 420 which adjust the respective phases and amplitudes of signals transmitted by and/or received from the EM antenna elements. The phases and amplitudes are adjusted based on respective control signals provided to T/R modules 420.

Optionally, the phased array antenna includes beam steering controller 440 which steers the phased array antenna beam by generating the control signals for T/R modules 420. Beam steering controller 440 may include analog and/or digital circuitry.

Optionally, beam steering controller 440 includes at least one data processor, which may serve, for example, to determine the respective magnitudes of the control signals to obtain a specified scan angle. Optionally, the direction is determined from steering data obtained from a system controller.

Optionally, beam steering controller 440 includes at least one memory (volatile and/or non-volatile) for storing instructions for execution by the processor and/or data.

Optionally, beam steering controller 440 includes at least one analog to digital (A/D) converter that generates analog control signals for the T/R elements.

Alternately or additionally, the A/D converter(s) digitize calibration output signals returned from antenna array 410 during a calibration process. Beam steering circuitry may use the digitized calibration signals to calculate correction factors for the control signals in order to steer the antenna beam accurately.

Optionally, beam steering controller 440 includes a digital signal processor for processing the digitized calibration signals.

Optionally, phased array antenna 410 is connected via T/R modules 420 to a receiver and/or transmitter, shown schematically as receiver/transmitter 430.

### III. Results

III.a. Phased array antenna

Simulations were performed for a phased array antenna formed of ME antenna elements disclosed herein (i.e. primary antenna with a passive radiator layer above) relative to the primary antenna without a passive radiator layer above. The results demonstrate the improved performance obtained when the ME antenna elements include a passive radiator layer stacked above the primary antenna.

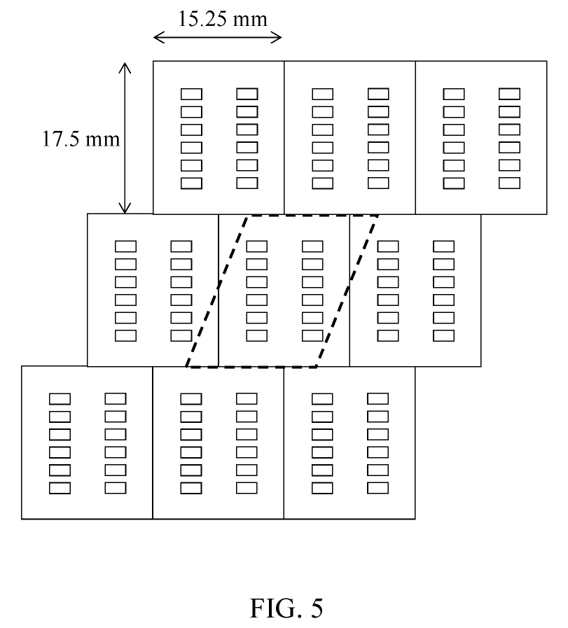

Reference is now made to FIG. 5, which is a simplified illustration of the structure of the simulated phased array grid. The antenna array is a three by three grid of antenna elements arranged in a parallelogram pattern (see dashed parallelogram overlaid on the grid of antenna elements). The size of each antenna element is 17.5 mm by 15.25 mm. When the antenna is simulated with passive radiator layers, the passive radiator layer for each antenna element includes ten passive radiators arranged as shown.

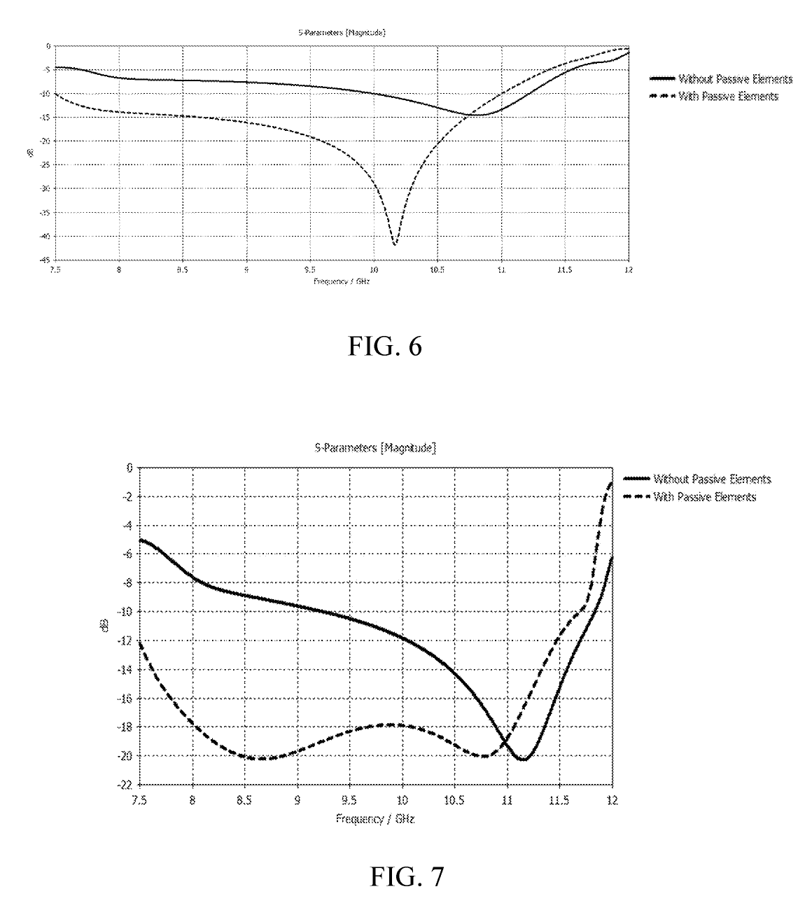

Reference is now made to FIG. 6, which shows the simulation results of the return loss of a phased array antenna with and without a passive radiator layer when scanning out to 60 degrees. The solid line shows the results for the antenna without passive radiators and the dashed line shows the results for the antenna with passive radiators. The bandwidth of the antenna without passive radiators (for a return loss of less than -10 dB) is 10-11.25 GHz. The bandwidth of antenna with passive radiators is much wider, 7.5-11 GHz.

A similar increase in bandwidth is demonstrated in FIG. 7, which shows the results obtained for the antenna when scanned out to 50 degrees. The bandwidth of the antenna without passive radiators is 9.25-11.75 GHz. The bandwidth of antenna with passive radiators is much wider, from less than 7.5 GHz to 11.6 GHz.

III.b. Single antenna

Simulations were performed for a single ME antenna element according to embodiments of the disclosure. The simulation results show the performance of an ME antenna having a passive radiator layer above the primary antenna relative to the primary antenna alone (e.g. without a passive radiator layer). The size of the antenna element is 17.5 mm by 15.25 mm, similar to the antenna elements of the simulated phased array antenna. The results demonstrate the improved performance obtained when the ME antenna includes a passive radiator layer stacked above the primary antenna.

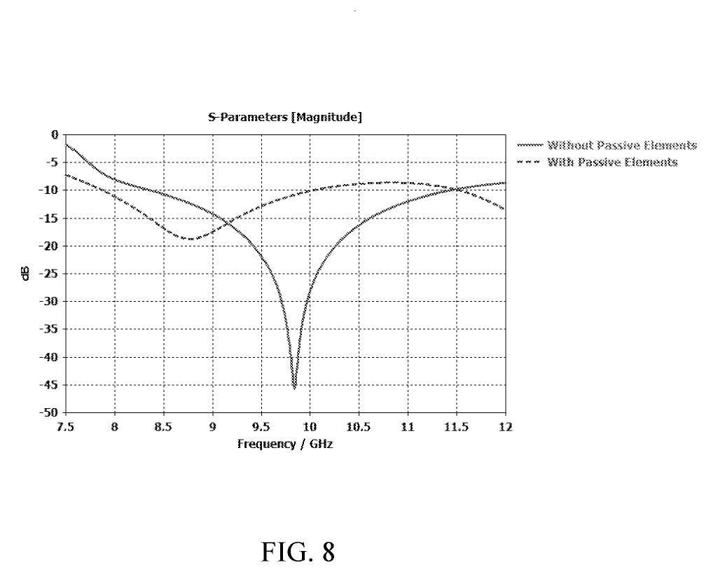

Reference is now made to FIG. 8, which shows the simulation results of the return loss of an ME primary antenna with and without a passive radiator layer. The solid line shows the results for the antenna without passive radiators and the dashed line shows the results for the antenna with passive radiators. The bandwidth of the antenna without passive radiators for a return loss of less than -10 dB is approximately 8.25-11.5 GHz. The bandwidth of antenna with passive radiators for a return loss of less than -8 dB is approximately GHz 7.5 to over 12 GHz. For the majority of this band the return loss is less than -10 dB.

### General

It is expected that during the life of a patent maturing from this application many relevant ME antenna configurations, ME antenna manufacturing technologies, electric radiators, magnetic radiators, passive radiators, dielectric materials, dielectric substrates and phased array antennas will be developed and the scope of the terms primary antenna, ME antenna, electric radiator, magnetic radiator, passive radiator, dielectric material, dielectric substrate and phased array antenna are intended to include all such new technologies a priori.

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or document(s) related to this application (e.g., co-filed) are hereby incorporated herein by reference in its/their entirety.

Where section headings are used in this document, they should not be interpreted as necessarily limiting.

1. A magneto-electric antenna, comprising:
a primary antenna comprising:
at least one magnetic radiator, configured to generate a magnetic field;
at least one electric radiator, configured to generate an electric field oriented orthogonally to the magnetic field; and
at least one antenna feed, configured to couple at least one feed line to the at least one magnetic radiator and to the at least one electric radiator; and
at least one passive radiator layer stacked above said primary antenna, each of said at least one passive radiator layers respectively comprising at least one passive radiator capacitively coupled to said primary antenna.

2. The magneto-electric antenna according to claim 1, wherein said at least one passive radiator layers are physically separated from said primary antenna by a dielectric substance.

3. The magneto-electric antenna according to claim 1, wherein said at least one passive radiator layers are conductively disconnected from said primary antenna.

4. The magneto-electric antenna according to claim 1, wherein at least one of said passive radiator layers comprises a respective dielectric substrate having an upper surface and a lower surface, said at least one passive radiator being disposed on said top surface and said primary antenna being located below said bottom surface.

5. The magneto-electric antenna according to claim 1, wherein at least one of said passive radiator layers comprises a respective dielectric substrate having an upper surface and a lower surface, said at least one passive radiator being disposed on said bottom surface and said primary antenna being located below said bottom surface, wherein said at least one passive radiator is conductively disconnected from said primary antenna.

6. The magneto-electric antenna according to claim 1, wherein said at least one passive radiator layers comprise a patterned conductive material disposed on a surface of a respective dielectric substrate, the patterned conductive material forming a resonator.

7. The magneto-electric antenna according to claim 1, wherein each of said at least one passive radiator layers comprises an array of passive radiators.

8. The magneto-electric antenna according to claim 1, wherein the electric radiator comprises at least one dipole antenna.

9. The magneto-electric antenna according to claim 1, further comprising a radome.

10. The magneto-electric antenna according to claim 9, wherein at least one of said passive radiator layers is incorporated into said radome.

11. The magneto-electric antenna according to claim 9, wherein said radome is positioned above said passive radiator layer.

12. The magneto-electric antenna according to claim 1, wherein the magneto-electric antenna comprises a printed-circuit antenna.

13. The magneto-electric antenna according to claim 1, wherein the magneto-electric antenna comprises a machined metal antenna.

14. The magneto-electric antenna according to claim 1, wherein the magneto-electric antenna comprises a three-dimensional (3D) printed antenna.

15. The magneto-electric antenna according to claim 1, wherein said primary antenna is dual-polarized.

16. An array antenna, comprising:
an array of magneto-electric antennas, each of said magneto-electric antennas respectively comprising:
a primary antenna comprising:
at least one magnetic radiator, configured to generate a magnetic field;
at least one electric radiator, configured to generate an electric field oriented orthogonally to the magnetic field; and
at least one antenna feed, configured to couple at least one feed line to the at least one magnetic radiator and to the at least one electric radiator; and
at least one passive radiator layer stacked above said primary antenna, each of said at least one passive radiator layers respectively comprising at least one passive radiator capacitively coupled to said primary antenna.

17. The array antenna according to claim 16, wherein said primary antennas are dual-polarized.

18. The array antenna according to claim 16, further comprising transmit/receive (T/R) modules associated with respective magneto-electric antennas, configured to adjust at least one of a respective phase and a respective amplitude of signals applied to the magneto-electric antennas such that said array antenna is operable as a phased array antenna.
